(19) United States
(12) Patent Application Publication
(10) Pub. No.: US 2022/0251823 A1
(43) Pub. Date: Aug. 11, 2022

(54) WOOD CONNECTION AND A LAMINATED WOOD TOWER COMPRISING A PLURALITY OF SUCH WOOD CONNECTIONS

(71) Applicant: Modvion AB, Hisings Backa (SE)

(72) Inventors: Erik DÖLERUD, Göteborg (SE); Anders WICKSTRÖM, Karlstad (SE)

(21) Appl. No.: 17/607,174

(22) PCT Filed: May 7, 2020
(86) PCT No.: PCT/SE2020/050469

§ 371 Date: Oct. 28, 2021

(30) Foreign Application Priority Data
May 9, 2019 (SE) 1950561-9

(51) Int. Cl. E04B 1/26; E04H 12/04; E04H 12/34; B32B 21/13; B32B 21/14

(52) U.S. Cl. CPC E04B 1/2604; E04H 12/04; E04H 12/342; F03D 13/20; B32B 21/14; E04B 2001/264; E04B 2001/2648; B32B 21/13

(57) ABSTRACT

Wood connection for large wooden constructions comprising a first wood module, a second wood module and a perforated steel plate comprising a plurality of holes, where the first wood module and the second wood module comprises a plurality of laminated wood layers, where each wood layer comprises a plurality of laminated veneer plies, where a first part of the perforated steel plate is mounted in the first wood module with glue, and where a second part of the perforated steel plate is mounted in the second wood module with glue, with a centreline of the perforated steel plate aligned with a split line between the first wood module and the second wood module, and where the perforated steel plate has a tensile strength exceeding 700 MPa and that a wood module is at least 6 cm thick and has a tensile strength exceeding 20 MPa.

### TECHNICAL FIELD

The present invention relates to a connection connecting two wooden parts. Each wooden part is provided with at least one slit into which a perforated metal plate is glued.

### BACKGROUND ART

Wooden constructions of larger sizes are getting more and more popular, both for buildings such as multi-story houses and for other commercial wooden constructions. Some buildings are designed using a combination of steel or concrete and wood, and some are designed using wood in both load-carrying beams and cladding.

One type of wooden construction that is becoming more popular is wooden towers that may be used for a number of different purposes. They may e.g. be used as transmitter masts or for wind power installations. A typical wind power installation is provided with a tower made of steel or concrete. The tower is attached to the ground by a foundation and the tower is provided with a nacelle at the top of the tower, holding the generator, the transmission and the rotor blades. A steel tower is normally assembled by steel rings either bolted together or welded to each other. A concrete tower may be assembled from concrete parts joined together or may be made by sliding form casting.

These conventional towers work well but have some disadvantages. One disadvantage is that they are heavy. A heavy tower requires a very stable foundation, which in turn requires a lot of e.g. concrete. Due to efficiency, the wind power installations are often built in areas lacking roads, which complicate the transport of material to the site. Since large amounts of material are required for a tower, extensive transportation is required. A further disadvantage is when the life time of a tower is reached and the tower must be disassembled. In this case, all material must be handled and transported again.

A wooden tower for a wind power installation has been proposed in WO2010121733. The proposed tower is built by using an inner frame made by plane elements, to which a load carrying coating is applied. The plane elements may be made from laminated plywood and/or wood composite materials. The plane elements may be connected by using perforated steel plates that are inserted in slits that are cut or routed in the edges of the elements. The slits are thereafter filled with an adhesive that will glue the steel plates and the plane elements together. This type of wood-steel connection is described in detail in the German General Building Authority Approval no. Z-9.1-770 by DIBt (Deutsches Institut für Bautechnik). This type of connection is suitable to transmit up to 10 MPa of tensile stress.

U.S. Pat. No. 5,966,892 shows a connection adapted to connect two or more wooden elements to each other, where a metal plate is nailed and/or glued to a wood element, and where the wood elements are connected with screws. U.S. Pat. No. 5,660,492 shows different types of wood connections, where a connector base is adhered in wood pockets of wood elements.

These types of connections are well adapted for connections between wood elements where moderate forces are present, but there is still room for an improved wood connection having an improved load carrying ability.

### DISCLOSURE OF INVENTION

An object of the invention is therefore to provide an improved wood connection for laminated wood modules comprising laminated veneer lumber. A further object of the invention is a laminated wood tower comprising a plurality of such wood connections.

The solution to the problem according to the invention is described in the characterizing part of claim 1 for the wood connection and in claim 15 for the laminated wood tower. The other claims contain advantageous embodiments and further developments of the wood connection.

In a wood connection for large wooden constructions comprising a first wood module, a second wood module and a perforated steel plate comprising a plurality of holes, where the first wood module and the second wood module comprises a plurality of laminated wood layers, where each wood layer comprises a plurality of laminated veneer plies, where a first part of the perforated steel plate is mounted in the first wood module with glue, and where a second part of the perforated steel plate is mounted in the second wood module with glue, with a centreline of the perforated steel plate aligned with a split line between the first wood module and the second wood module, the object of the invention is achieved in that the perforated steel plate has a tensile strength exceeding 700 MPa and that a wood module is at least 6 cm thick and has a tensile strength exceeding 20 MPa.

By this first embodiment of a wood connection, a connection that can connect two laminated wood modules is provided. By using a high tensile strength perforated steel plate with a tensile strength exceeding 700 MPa, a connection that can handle the strength of laminated veneer lumber (LVL) modules is provided. Since the tensile strength of laminated veneer lumber is in the range of 30 MPa, and the strength of the known DIBt connection is in the range of 10 MPa, the known DIBt connection can not utilize the full potential of laminated veneer lumber. By using the known connection with laminated veneer lumber, the connection will be the limiting factor. The known connection is well suited to connect cross laminated lumber (CLT) modules, which have a tensile strength in the range of 10 MPa. Using the known connection with laminated veneer lumber in order to transfer higher loads, the wall thickness of a module would have to be three times thicker to be able to handle a load up to 30 MPa with the known connection. Such a solution would be impractical since an unnecessary amount of LVL would have to be used to allow the known connection to handle the higher load, which would increase the weight and the cost of the end construction. By using the inventive wood connection, the wood connection will be match the tensile strength of the LVL module and will not restrict the finished product. The wood connection will thus allow for e.g. higher laminated wood towers.

Tensile strength, which is also referred to as ultimate tensile strength, is the capacity of a material or structure to withstand loads tending to elongate the material or structure. In other words, tensile strength resists tension. Tensile strength is measured by the maximum stress that a material can withstand while being stretched or pulled before breaking. The tensile strength is found by performing a tensile test and recording the engineering stress versus strain. Tensile strength is defined as a stress, which is measured as force per unit area. In the International System of Units (SI), the unit is Pascal (Pa).

A wood module may be flat or may be curved in one direction and comprises a plurality of laminated wood layers, each layer comprising a plurality of laminated veneer plies. In a flat module, the direction of the veneer layers may be selected as required, e.g. with every second veneer ply arranged in a perpendicular direction to the other veneer plies. Each layer may also comprise veneer plies that are all directed in the same direction, and where the veneer plies of two adjacent layers are perpendicular.

For a curved module, each layer comprises a first set of plies, where the first set of plies comprises a plurality of plies arranged adjacent each other and where the wood grain is directed in a first direction, and a second set of plies, where the second set of plies comprises one or more plies arranged adjacent each other and where the wood grain is directed in a second direction, where the first direction is perpendicular to the second direction. By using a layer having a second set of plies having the wood grain in a perpendicular direction to the first set of plies, it is possible to bend a layer and in this way obtain a curved module having a high tensile strength. In order to be able to connect the curved modules in a reliable and cost-effective way and at the same time to preserve the tensile strength of the curved modules through the connection between the curved modules, a perforated steel plate having a tensile strength exceeding 700 MPa is used. By using the inventive wood connection, the total tensile strength of the laminated veneer lumber modules can be utilized in the finished product.

One advantage of the invention is that the wood modules can be connected to each other with the connection elements embedded within the wood modules. This simplifies the connection of the wood modules and allows for a smooth outer side and a smooth inner side of the finished product. A further advantage of embedding the connection is that the connecting element is protected from outer environmental influences. This is especially advantageous for the outer surface of the finished product. If an outer protection treatment, e.g. a protective film, is to be applied to the finished product, it is also of advantage to have a smooth outer surface.

Wood, and especially spruce or pine, is a cheap and strong material suitable to be used for laminating layers of thin plies. Other fibers may also be used, such as bamboo fibers, which may be laminated into layers with the fibers in a desired direction.

Each wood module is provided with slits that are adapted to house half of a perforated steel plate. A slit may be cut or routed into the edges of a wood module. In one example, the outer surface of a module is closed and the slit is provided from the closed wall of the outer surface to the inner surface. The perforated steel plate may be inserted from above or from the side of the wood module. The slit is slightly wider than the thickness of the perforated steel plate, and is preferably 2 mm wider than the thickness of a perforated steel plate. The perforated steel plate is further centralized in the slit during mounting, such that the glue can spread evenly on both sides of the perforated steel plate.

The perforated steel plate may for this reason be provided with protrusions on each side that will provide a distance means for the perforated steel plate. The protrusions are preferably embossed to the perforated steel plate during manufacture.

Each perforated steel plate comprises a plurality of holes. Each hole may have a diameter of e.g. 10 mm or more. The holes are positioned with a predefined distance to other holes, and have a predefined distance to the sides of the perforated steel plate. There is further a predefined distance between the centre line of the perforated steel plate and the closest holes. The holes may be placed in rows and columns, or may be positioned with an offset arrangement. It is also possible to vary the density of holes over the perforated steel plate. In one example, the hole density closer to the split line between two wood modules is decreased.

When a perforated steel plate is positioned in a slit, glue is injected into the slit such that half of a steel plate is glued to a module. An open side of the slit is preferably covered before glue is inserted, such that the slit is completely filled and that the glue does not escape during hardening.

Preferably, the perforated steel plates are mounted to the wood modules when the end product is assembled. The number of perforated steel plates used for a module is defined by calculation of the required forces that the joint must withstand.

The wood connection may be used for different wood product made from modules of laminated veneer layers. In one example, curved modules for a wind power plant are attached to each other by the use of a plurality of wood connections.

### BRIEF DESCRIPTION OF DRAWINGS

The invention will be described in greater detail in the following, with reference to the embodiments that are shown in the attached drawings, in which

FIG. 1 shows an example of a wood connection according to the invention in a curved wood module,

FIG. 2 shows an example of a wood layer to be used in a wood module,

FIG. 3 shows an example of a perforated steel plate used in a wood connection according to the invention,

FIG. 4 shows a further example of a perforated steel plate used in a wood connection according to the invention,

FIG. 5 shows an example of a laminated wood tower comprising a plurality of wood connections according to the invention, and

FIG. 6 shows an example of a wind power tower according to the invention.

### MODES FOR CARRYING OUT THE INVENTION

The embodiments of the invention with further developments described in the following are to be regarded only as examples and are in no way to limit the scope of the protection provided by the patent claims. The directional references used refer to directions of a curved wood module when used in a laminated wood tower.

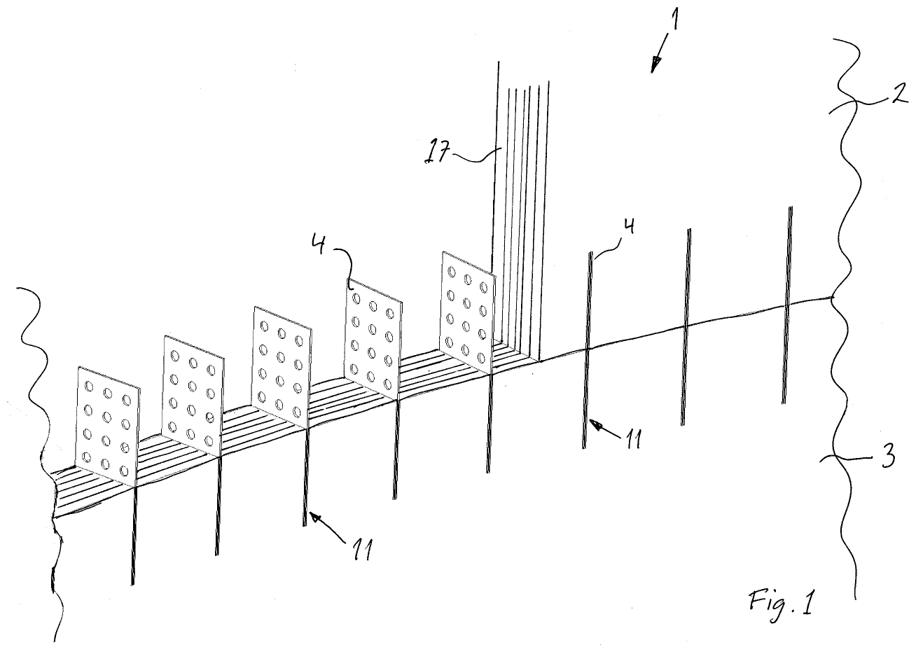

FIG. 1 shows a first example of a wood connection. The wood connection 1 comprises a first wood module 2, a second wood module 3 and a perforated steel plate 4. The first wood module 2 and the second wood module 3 both comprise a plurality of laminated layers 17. The first wood module 2 and the second wood module 3 preferably have the same layout with the same amount of laminated layers of the same type. In one example, a module comprises five layers. The layers are press glued to each other such that a solid wood module 2, 3 is obtained. A wood module is provided with an upper edge, a lower edge, a first side surface, a second side surface, an inner surface 21 and an outer surface 22. In the shown example, the wood modules are curved in one direction, but the wood modules may also be flat. A layer 17 comprises a plurality of laminated veneer plies 18. In a flat layer, the direction of the fibres of the veneer plies may be selected freely, and may e.g. be directed in the same direction. Some plies may also be arranged with the direction of the fibres directed in a perpendicular direction when compared to the other plies. In one example, every second ply is arranged in one direction, and the other plies are directed perpendicular those plies.

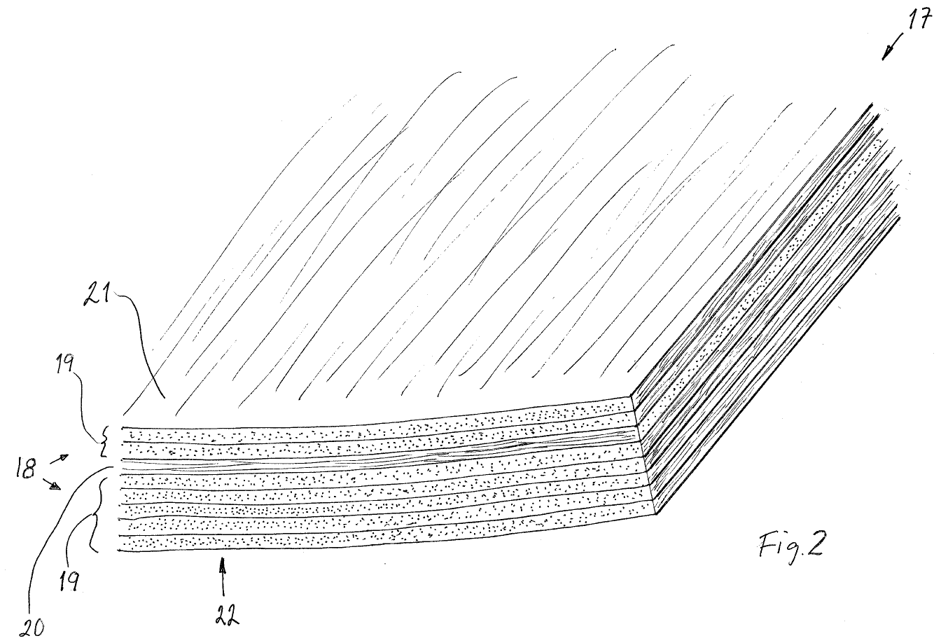

A wood layer for a curved module is shown in FIG. 2. In the shown wood layer 17, the direction of the fibres of the veneer plies 18 of a first set of plies are directed in the same direction. The first set of plies 19 contain most of the plies, and preferably at least 80% of the number of plies. A layer further comprises a second set of plies 20 comprising one or more plies with the direction of the fibres directed in a perpendicular direction when compared to the first set of plies. Preferably, the second set of plies comprise one ply, but may comprise two veneer plies arranged adjacent each other.

The second set of plies 20, i.e. the set of plies having a grain direction perpendicular to the first set of plies 19 of a layer, may be arranged at any position of the layer, but is preferably arranged close to one side of the layer. In one example, the second set of plies is arranged as the outermost set of plies of a layer. In another example, the second set of plies is arranged within the first set of plies. A first part of the first set of plies is now arranged on one side of the second set of plies, and a second part of the first set of plies is arranged on the other side of the second set of plies. The use of a single set of plies arranged in a crosswise manner will strengthen the layer and will still allow the layer to be bent to a curved shape.

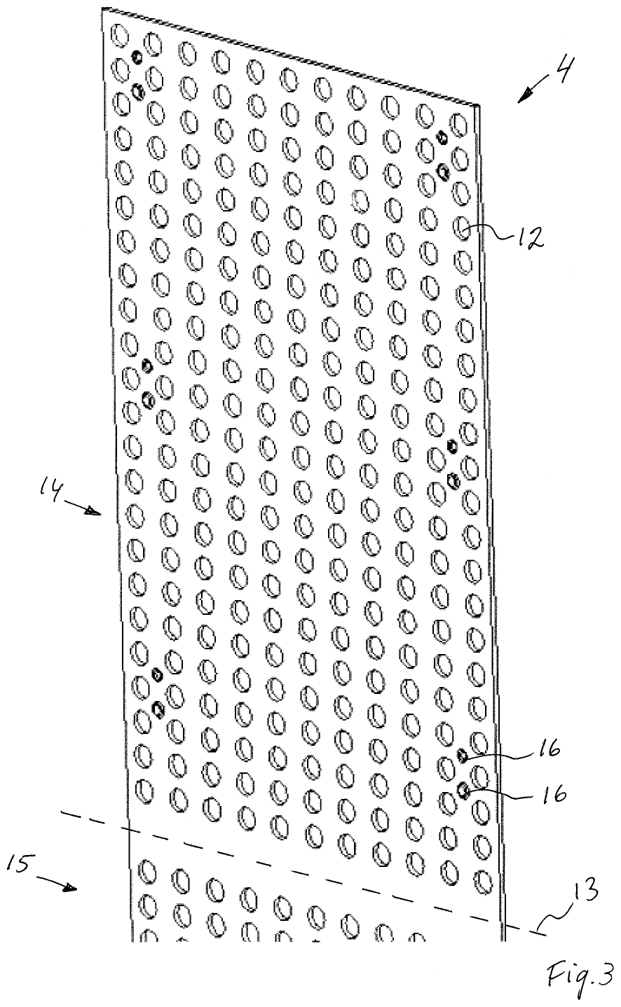

The wood modules are connected to each other by the use of a perforated steel plate 4. A first example of perforated steel plate is shown in FIG. 3. Each wood module is provided with a slit 11 for each perforated steel plate. In the shown example, a slit 11 runs in a cross direction of a wood module, i.e. from the outer surface to the inner surface of the wood module, perpendicular to the inner surface 21 and the outer surface 22 of a wood module. In other applications, especially for flat modules, a slit may also run parallel to the outer surface. The slit may be cut by e.g. a circular saw or a router. One advantage of using a router is that the slit must not continue through the complete wood module. With a router, a thin wall can be left at the outer surface of the wood module. In this way, the outer surface of the wood module will be closed. This will allow the wood module to have a smooth outer surface that does not have to be patched to cover the slit in the outer surface.

The width of the slit is wider than the perforated steel plate. Preferably, a nominal gap of 1 mm between the perforated steel plate and each side wall of the slit is provided. The perforated steel plate 4 is preferably provided with one or more protrusions 16 that will provide a distance means for the perforated steel plate, such that a desired gap is created when the steel plate is positioned in a gap. A protrusion preferably extends 1 mm from the surface of the perforated steel plate in each direction, corresponding to the nominal gap of the slit. This will allow the perforated steel plate to be centralized in the slit during mounting, such that the glue can spread evenly on both sides of the perforated steel plate. The protrusions are preferably embossed into the perforated steel plate during manufacture.

A perforated steel plate may have different shapes, but a rectangular shape is preferred. The perforated steel plate comprises a first part 14 and a second part 15 divided by a centre line 13. The perforated steel plate is symmetrical with respect to the centre line, such that the first part and the second part are identical. The first part is adapted to be mounted in a first wood module, and the second part is adapted to be mounted in a second wood module, with the centre line 13 arranged at the split line of the connection, aligned with the upper edge of a first wood module 2 and the lower edge of a second wood module 3. The width of the perforated steel plate will depend on the thickness of the wood module, but is at least 60 mm, and the length is at least 500 mm. The thickness of the perforated steel plate is preferably between 2-4 mm.

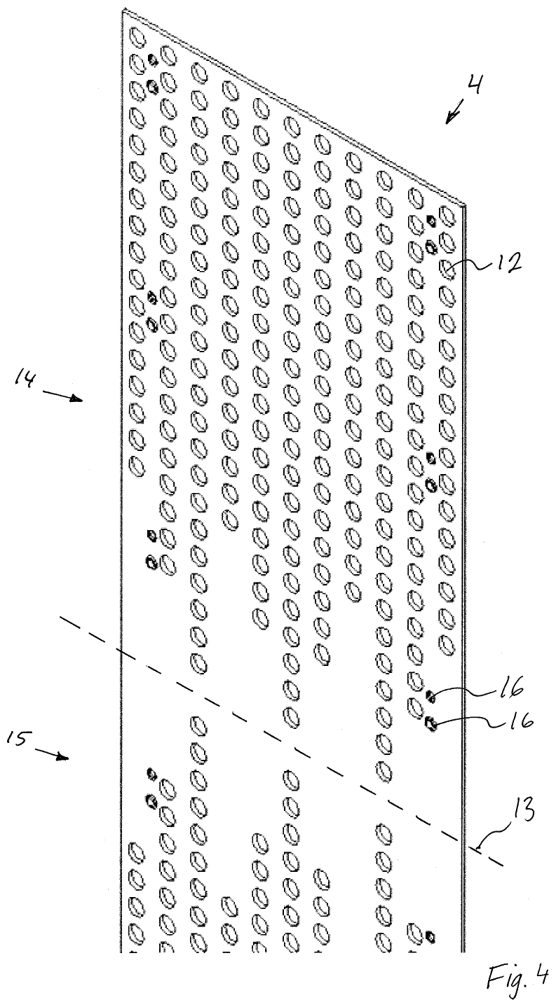

The perforated steel plate 4 comprises a plurality of holes 12. The holes are in the shown example circular, but other shapes are also possible, such as elliptic or oval holes. A circular hole preferably has a diameter of 10 mm, but other sizes are possible. The holes are positioned with a predefined distance to the other holes, and have a predefined distance to the sides of the perforated steel plate. There is further a predefined distance between the centre line of the perforated steel plate and the closest holes. The holes may be placed in rows and columns, or may be positioned with an offset arrangement. It is also possible to vary the hole density of the perforated steel plate. FIG. 4 shows an example of a perforated steel plate where the hole density closest to the centre line is reduced.

The perforated steel plate is mounted to a wood module by the use of glue. The glue is preferably injected into the slit after the perforated steel plate has been positioned in the slit. It is also possible to fill the slit with a predefined amount of glue and to insert the perforated steel plate thereafter. In this case, it is of advantage to vibrate the perforated steel plate such that air can escape.

When a perforated steel plate is positioned in a slit, glue is injected into the slit such that half of a perforated steel plate is glued to a wood module. An open side of the slit is preferably covered before glue is inserted, such that the slit is completely filled and that the glue does not escape during hardening. Tape or the like may be used to cover the slit of the wood module.

Preferably, the perforated steel plates are mounted to the wood modules during assembly of the end product. The number of perforated steel plates used for a module is defined by calculation of the required forces that the joint must withstand. Different types of glue may be used. A suitable glue is a two-component glue, e.g. based on an epoxy resin, but other types may also be used, such as moisture cured polyurethanes. The glue is preferably injected from the lowest part of the slit, such that the glue will be able to spread evenly and such that no air bubbles are enclosed. The glue may be injected through a drilled injection hole that is plugged after the injection.

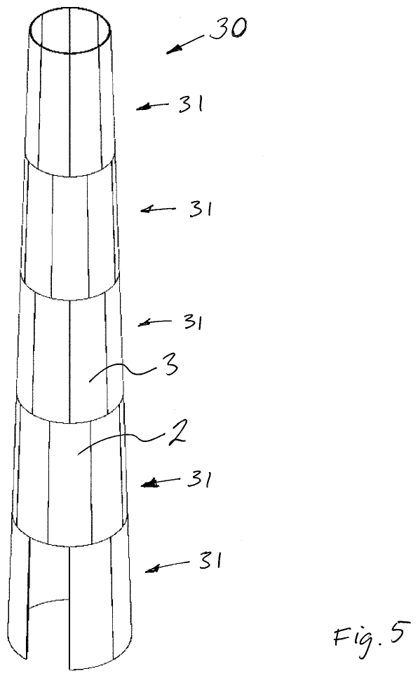

The wood connection 1 may be used to connect laminated veneer lumber wood modules of different sizes and shapes. In one example, the wood connection is used for mounting a laminated wood tower 30, where curved modules 2, 3 are mounted to each other to form circular sections 31, where each circular section comprises a plurality of curved modules 2, 3. An example of a laminated wood tower is shown in FIG. 5. The circular sections are then mounted to each other to form the laminated wood tower by the use of wood connections 1. The mounting of the curved modules to form a circular section may be made with a specific joint, which could comprise e.g. rabbets of a curved module that cooperates with rabbets of an adjacent curved module, where the curved modules may lock to each other. It is also possible to use overlapping joints, where some layers of a curved module overlap some layers of an adjacent curved module. The curved modules are preferably mounted to each other in a sideway direction with glue and screws. It is also possible to use perforated steel plates to mount the curved modules to a circular section.

The circular sections are mounted to each other by using the inventive wood connection 1. The wood connection can withstand the tensile forces that arise when the wind turbine is subjected to air forces. One side of the tower will be subjected to compression forces, which will be handled by the wood modules, and the other side will be subjected to tensile forces which will be handled by the curved wood modules and the wood connections. The wood connection is thus designed to correspond to the same tensile load capacity as the curved modules. Bending and torsional forces will be handled by the cross lamination of the curved modules.

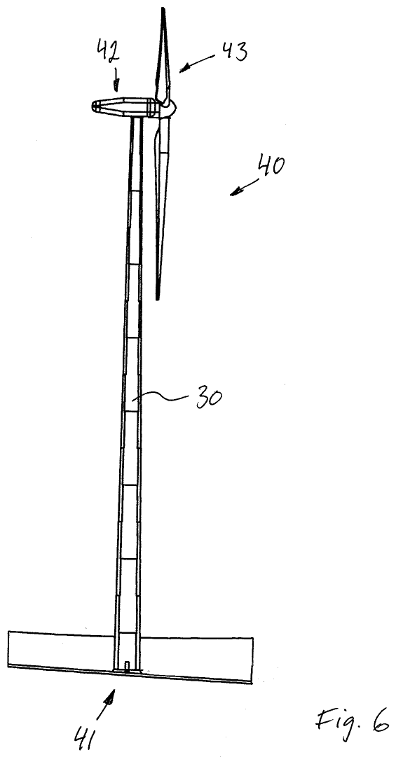

FIG. 6 shows an example of a wind power tower 40 comprising a laminated wood tower 30. The shown wind power tower may be up to 100 meters and more, and is in the shown example tapered somewhat towards the top of the tower. The tower is fixed to a foundation 41, e.g. comprising steel bars extending up in the tower, to which the lower wooden section is attached with e.g. screws. A door may be provided in one of the lower curved modules. On top of the tower, a nacelle 42 comprising a rotor 43 and a generator is provided. Depending on the type of generator used, a transmission may also be installed.

The invention is not to be regarded as being limited to the embodiments described above, a number of additional variants and modifications being possible within the scope of the subsequent patent claims. A curved module may be used for other circular objects, such as wooden tubes, and may have various sizes. Straight wood sections may be used e.g. for larger walls in wooden housings.

### REFERENCE SIGNS

1: Wood connection
2: First curved module
3: Second curved module
4: Perforated steel plate
11: Slit
12: Hole
13: Centre line
14: First part
15: Second part
16: Protrusion
17: Wood layer
18: Veneer ply
19: First set of plies
20: Second set of plies
21: Inner surface
22: Outer surface
30: Laminated wood tower
31: Circular section
40: Wind power tower
41: Foundation
42: Nacelle
43: Rotor

1. A wood connection for large wooden constructions comprising: a first wood module, a second wood module and a perforated steel plate comprising a plurality of holes, where the first wood module and the second wood module comprises a plurality of laminated wood layers, where each wood layer comprises a plurality of laminated veneer plies, where a first part of the perforated steel plate is mounted in the first wood module with glue, and where a second part of the perforated steel plate is mounted in the second wood module with glue, with a center line of the perforated steel plate aligned with a split line between the first wood module and the second wood module, wherein the perforated steel plate has a tensile strength exceeding 700 MPa and that a wood module is at least 6 cm thick and has a tensile strength exceeding 20 MPa.

2. The wood connection according to claim 1, wherein the perforated steel plate is arranged perpendicular to an inner surface and an outer surface of the laminated wood modules.

3. The wood connection according to claim 1, wherein a wood module is flat.

4. The wood connection according to claim 1, wherein a wood module is curved in a longitudinal direction of the wood module.

5. The wood connection according to claim 4, wherein a laminated wood layer comprises a first set of plies comprising a plurality of veneer plies and where the wood grain is directed in a first direction, and a second set of plies comprising one or more veneer plies arranged adjacent each other and where the wood grain is directed in a second direction, where the first direction is perpendicular to the second direction.

6. The wood connection according to claim 1, wherein the first part and the second part of the perforated steel plate are symmetrical with respect to the center line of the perforated steel plate, and where the width of the perforated steel plate is at least 60 mm, and the length of the perforated steel plate is at least 500 mm.

7. The wood connection according to claim 1, wherein the holes of the perforated steel plate are circular, where the diameter of each hole is 10 mm.

8. The wood connection according to claim 1, wherein the hole density of the perforated steel plate is reduced adjacent the center line of the perforated steel plate.

9. The wood connection according to claim 1, wherein each side edge of the perforated steel plate comprises at least one protrusion which extends 1 mm over the surface of the perforated steel plate.

10. The wood connection according to claim 1, wherein the distance from the center line to a hole closest to the center line is at least 20 mm.

11. The wood connection according to claim 1, wherein a perforated steel plate comprises at least 6 holes.

12. The wood connection according to claim 1, wherein the perforated steel plate is at least 2 mm thick.

13. The wood connection according to claim 1, wherein the thickness of a ply is between 1-5 mm.

14. The wood connection according to claim 1, wherein a laminated wood layer comprises between 5-15 plies.

15. A laminated wood tower, wherein the laminated wood tower comprises a plurality of wood connections according to claim 4.
